(19) United States
(12) Patent Application Publication
(10) Pub. No.: US 2014/0012616 A1
(43) Pub. Date: Jan. 9, 2014

(54) SYSTEMS AND METHODS FOR NEW LOCATION TASK COMPLETION AND ENTERPRISE-WIDE PROJECT INITIATIVE TRACKING

(71) Applicant: EHSolution.com, Fort Lauderdale, FL (US)

(72) Inventor: Richard Moshenek, Fort Lauderdale, FL (US)

(21) Appl. No.: 13/931,686

(22) Filed: Jun. 28, 2013

Related U.S. Application Data
(60) Provisional application No. 61/668,008, filed on Jul. 4, 2012.

(51) Int. Cl. G06Q 10/06

(52) U.S. Cl. CPC G06Q 10/063114
USPC 705/7.15

(57) ABSTRACT

The present invention describes a computer-implemented system and method for creating and managing a task list for multiple franchise locations in an online work management system accessible to users. In some embodiments of the invention, users create multiple baselines with multiple tasks based on location attributes than can be combined into a unique, dynamic master task list for a particular location. Embodiments of the invention allow tasks to be associated with a timeline of franchise preparation, a subset of tasks to be selected based on keyword or filtering by various attributes, adding additional tasks to a particular franchise master list based on various attributes, adding tasks to multiple locations at the same time dynamically based on various attributes, restricting task list access based on user community or group, altering user access and tasks dynamically based on changing baseline characteristics, and providing a master task list dynamically on a user interface.

### REFERENCE TO RELATED APPLICATIONS

The present application claims priority from provisional application U.S. Ser. No. 61/668,008, entitled “Systems and methods for New Location Task Completion and Enterprise-Wide Project Initiative Tracking,” filed on Jul. 4, 2012, the entirety of which is hereby incorporated by reference herein.

### FIELD OF THE INVENTION

The present invention broadly relates to a system and method for creating and managing a task list for one or more franchise locations in an online work management system that improves efficiency and solves communication problems compared to existing systems and methods.

### BACKGROUND OF THE INVENTION

When building or opening a new location, hotel companies and other franchisors are challenged with communicating to store managers a checklist of thousands of tasks to be completed in order to have a successful opening. These tasks range from Human Resources to building permits to marketing. Typically each task contains notation on what should be accomplished, who within the organization should accomplish it, who should be contacted for assistance and how to obtain additional information. For each task, locations need the ability to update the status of each assignment, their current progression, any notations or files related to completion and ultimately indicate that the task is complete.

To communicate these tasks, most organizations relied on non-database oriented documents such as MICROSOFT EXCEL or WORD. Where it does accomplish the task of communicating the initial needs, the industry is then faced with new challenges.

First, how does a company maintain a single line of communication when these documents are forwarded over and over to other colleagues and subordinates? As multiple copies are created, everyone involved from the franchisor to the franchisee has lost control on what has been accomplished and who has accomplished it. Without a clear determination as to who manages a master version, no one knows the overall progression of the location's opening goals. The location may have missed key milestone tasks to prepare for opening without anyone recognizing this pitfall.

Secondly, as each location is provided with hundreds or thousands of items to complete, these items are constantly in flux. Information is constantly changing including the person to contact to ask questions, their email and contact details, or links for reference material. Using a WORD or EXCEL format, Franchisors have an impossible chore to communicate these updates via email and hope the email is read and comprehended by individuals that need to know the information.

Third, with each new opening, new learning and best practices need to be shared with upcoming locations. As with updates, Franchisors are dependent on email and verbal comments to communicate these messages, with no confirmation that the information is reaching the right target audience.

Lastly, after locations are opened, new initiatives and updates are constantly being introduced by the Franchisor. A core franchising benefit is that the franchisor will assist in marketing and promotional related items in order to retain the brand image and maintain or increase customer intent to return. New initiatives will include a list of to-dos that each location will need to complete and after completion locations need to certify that the initiative is implemented. The location is then held accountable for the initiative by the franchise Quality Assurance team.

The features and advantages described herein are not all-inclusive and many additional features and advantages will be apparent to one of ordinary skill in the art in view of the figures and description. Moreover, it should be note that the language used in the specification has been principally selected for readability and instructional purposes, and not to limit the scope of the inventive subject matter.

It is against this background that various embodiments of the present invention were developed.

### BRIEF SUMMARY OF THE INVENTION

### Definition of Terms

Task: A single piece of work to be completed. Each task is associated with a timeline, defined below. Tasks may also contain additional identifiers for activities. In one embodiment of the present invention, one task is to affix a welcome sign to the front of a building. The task further contains the contact information for a sign-maker and a corporate contact to report potential difficulties.

Community: A category of users that is defined by software subscription purchasers. Communities may each possess different levels of access to view and edit tasks. There may be an unlimited number of communities. In one embodiment of the present invention, a subscription owner may create user groups for local employees, regional employees, and corporate employees.

User Group: A category of users predetermined by the software developer. User groups may each possess different modules to view and edit tasks. There may be an unlimited number of user groups. In one embodiment of the present invention, there are five predetermined user groups: general users, moderators, administrators, subscription owners, and super-admin access personnel.

Access rights: The level of access granted to a community and/or user group relative to viewing and editing tasks.

Timeline: The amount of time remaining for a task to be completed. This is relative to the opening date of a franchise, or to a different date specified by the software subscription purchasers. In one embodiment of the present invention, tasks appear with a certain number of years, months, weeks, and days remaining for completion, this time corresponding to the scheduled opening date of the franchise.

Baseline: A software element that automatically populates a set of fields by a template, which template will automatically pre-populate the set of fields as the baseline data is changed. Each baseline corresponds to a particular attribute of a franchise location, and contains a unique combination of tasks. Some baselines are applicable to all franchise locations, while others are applicable only to certain franchise locations. In one embodiment of the present invention, in the setting of a fast-food chain franchise opening, one baseline corresponds to a drive-through feature, while another baseline corresponds to a children's play structure, while another baseline corresponds to a cashier counter.

Franchise: A location/unit licensed from, or directly owned by, a larger central organization.

Baseline World: Baseline World is a section from where the Subscription Moderator or Higher User will be able to do entire Task Management.

The present invention relates to a computer-implemented method for creating and managing a task list for one or more franchise locations in an online work management system accessible to one or more users by one or more user terminals, the method comprising the steps of: creating one or more baselines, each baseline containing one or more tasks, each baseline corresponding to a particular attribute of a franchise location and containing a unique combination of tasks unique to said particular attribute of the franchise location, wherein the baselines may be modified in real-time based on changing tasks for a given baseline; selecting one or more baselines from the created baselines based on attributes relevant to said franchise locations; creating a master task list for the one or more franchise locations utilizing the one or more selected baselines based on the attributes relevant to said franchise locations; combining said baselines to create said master task list, relevant to said franchise locations, said tasks each associated with a timeline of franchise preparation; selecting a subset of the tasks from the master task list prepopulated by the selected baselines by filtering for an attribute selected from the set consisting of status, department, discipline, due date, personnel assigned to task, project name, and milestone; adding one or more additional tasks to the master task list that are unique to each particular franchise location including information selected from the set consisting of task name, description, additional notes, due date, weeks out, personnel assigned to task, status, contact info, contact email, hyperlinks, milestone, department, community, phase, and project name; adding one or more tasks to multiple locations at the same time dynamically based on each locations' project's anticipated completion date; restricting access to viewing and modifying said tasks for the users based on the users' community and user group as determined by said baselines; altering said community and said user group access dynamically based on changing baseline characteristics; changing said tasks within said task list dynamically based on changes to corresponding baselines and the modification of baselines selected; and providing said master task list on a user interface to the one or more users utilizing the one or more user terminals, wherein the master task list, an opening date, and associated timeline of franchise preparation are dynamically updated in real-time based on an intersection of the selected baselines, and the community and user group of the user whenever the baselines, community, and user group of the user is modified.

The present invention further relates to a computer-implemented method for creating and managing a task list for one or more franchise locations in an online work management system accessible to one or more users by one or more user terminals, the method comprising the steps of: creating one or more baseline task lists specific to certain attributes of a franchise location, such a drive-through or an in-store children's playground, where each baseline has a combination of tasks specific to the attribute of the franchise location, where the baselines may be modified to reflect in the user's task list in real-time, and where one or more task lists can be created based on baselines. In one embodiment, one or more baselines can be created based on attributes relevant to franchise locations. In one embodiment, a master task list for a franchise location can be created utilizing one or more baselines. In one embodiment, tasks are associated with a timeline for franchise preparation. In one embodiment, a subset of tasks can be selected from the master list by filtering based on task attribute. In one embodiment, single tasks can be added to an already constructed master list. In one embodiment, tasks and/or baselines can be added at the same time to multiple franchise locations. This may be done on the basis of a project's anticipated completion date. In one embodiment, access to viewing and modifying tasks may be restricted based on a variable level of user access. This may be done on an individual basis, or on the basis of community and user group levels of access as determined by administrators. In one embodiment, this access may be changed based on changes to baselines. In one embodiment, changes to baselines will automatically make updates to individuals tasks in a task list or in a master list. In one embodiment, changes to tasks may change underlying baselines. In one embodiment, the master list is provided to a plurality of users in a user interface wherein the master list, opening date, and franchise preparation timeline are all updated in real-time.

The present invention also related to a system for creating and managing a task list for one or more franchise locations in an online work management system accessible to one or more users by one or more user terminals, comprising: a processor for processing program code; and one or more memories for storing program code, coupled to the processor, which when executed by the processor execute a process comprising the steps of: creating one or more baselines, each baseline containing one or more tasks, each baseline corresponding to a particular attribute of a franchise location and containing a unique combination of tasks unique to said particular attribute of the franchise location, wherein the baselines may be modified in real-time based on changing tasks for a given baseline; selecting one or more baselines from the created baselines based on attributes relevant to said franchise locations; creating a master task list for the one or more franchise locations utilizing the one or more selected baselines based on the attributes relevant to said franchise locations; combining said baselines to create said master task list, relevant to said franchise locations, said tasks each associated with a timeline of franchise preparation; selecting a subset of the tasks from the master task list prepopulated by the selected baselines by filtering for an attribute selected from the set consisting of status, department, discipline, due date, personnel assigned to task, project name, and milestone; adding one or more additional tasks to the master task list that are unique to each particular franchise location including information selected from the set consisting of task name, description, additional notes, due date, weeks out, personnel assigned to task, status, contact info, contact email, hyperlinks, milestone, department, community, phase, and project name; adding one or more tasks to multiple locations at the same time dynamically based on each locations' project's anticipated completion date; restricting access to viewing and modifying said tasks for the users based on the users' community and user group as determined by said baselines; altering said community and said user group access dynamically based on changing baseline characteristics; changing said tasks within said task list dynamically based on changes to corresponding baselines and the modification of baselines selected; and providing said master task list on a user interface to the one or more users utilizing the one or more user terminals, wherein the master task list, an opening date, and associated timeline of franchise preparation are dynamically updated in real-time based on an intersection of the selected baselines, and the community and user group of the user whenever the baselines, community, and user group of the user is modified.

Other features, utilities and advantages of the various embodiments of the invention will be apparent from the following more particular description of embodiments of the invention as illustrated in the accompanying drawings.

### BRIEF DESCRIPTION OF THE DRAWINGS

FIG. 1 is an overview diagram of an embodiment of the system architecture.

FIG. 2 (comprising FIGS. 2A and 2B) is an overview of an embodiment of the subscribers owner, administrator, moderator, and general user's system architecture.

FIG. 3 (comprising FIGS. 3A and 3B) is an overview diagram of an embodiment of electronic identification and security system architecture.

FIG. 4 illustrates an embodiment of hierarchical organization for subscription owners, administrators, moderators, and general users.

FIG. 5 illustrates an embodiment for location profile creation, allowing a user with appropriate access permissions to create a new franchise location, input property attributes, and to associate one or more baselines with the new location.

FIG. 6 illustrates an embodiment for users to search for a location, whereby users are able to search for location on the basis of a variety of attributes which function as filters, and through this interface to add, edit, purge, or inactivate existing locations.

FIG. 7 illustrates an embodiment of the project dashboard, which provides administrators with an overview of their project, displays information relevant to a project or subproject, and allows management tasks to be completed from this user interface, such as creating the project's task list and monitoring any files that have been uploaded that are associated with the project.

FIG. 8 illustrates an embodiment of the corporate dashboard, which provides users with appropriate access levels with an overview of all locations in which the users has access, including a graphical representation for each location so that user can quickly assess the overall progression of the location's task list, as well as providing the user with the ability to view any tasks that the user is responsible for completing in the near future.

FIG. 9 illustrates an embodiment of the location dashboard, which provides graphical representation of how a location is progressing with its tasks and allows users to modify information pertaining to a location or tasks.

FIG. 10 illustrates an embodiment of a task list, which is a listing of all of the pieces of work to be completed for a location, showing tasks which may be searched, unrestricted fields edited, new tasks added, or multiple tasks edited at once.

FIG. 11 illustrates an embodiment of task profile creation, which includes all of the different attributes that make up a task, the task description, relevant reference material, and the person to contact for assistance if needed; users may alter unrestricted fields in this interface, add notes, or add relevant files.

FIG. 12 illustrates an embodiment of Baseline World, a section from which a user with appropriate access is able to perform entire Task Management, allowing allows tasks and baselines to be edited, added, or deleted.

FIG. 13 illustrates an embodiment of task pushdown, which creates a new task with various attributes and creates it at multiple locations; tasks are inputted into location task lists based on weeks prior to completion, which is automatically calculated for each location.

FIG. 14 illustrates an embodiment of project pushdown, which allows a baseline to be added to one or more locations; baseline tasks are added with respect to a due date that the system calculates based on franchise preparation timeline.

FIG. 15 illustrates a flowchart of an embodiment of a method according to the present invention.

FIG. 16 illustrates a baseline depository according to one embodiment of the present invention wherein multiple baselines may be selected by a user to create one or more locations.

FIG. 17 illustrates a process in which once a location is created, restricted fields in each task remain finked to the baseline task, showing how if a restricted field is changed on the baseline task then the new data is immediately updated in the location's task.

### DETAILED DESCRIPTION OF THE INVENTION

In the following description, for purposes of explanation, numerous specific details are set forth in order to provide a thorough understanding of the invention. It will be apparent, however, to one skilled in the art that the invention can be practiced without these specific details. In other instances, structures and devices are shown in block diagram form in order to avoid obscuring the invention.

Reference in the specification to “one embodiment,” “an embodiment” or “the embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed descriptions that follow are presented in terms of methods and symbolic representations of operations on data bits within a computer memory. These algorithmic descriptions and representations are the means used by those skilled in the data processing arts to most effectively convey the substance of their work to others skilled in the art. A method is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared or otherwise manipulated. It has proven convenient at times, principally for reasons of common usage, to refer to these signals as bits, values, elements, symbols, characters, terms, numbers or the like.

It should be borne in mind, however, that all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or the like, refer to the action and processes of a computer system, a personal digital assistant (PDA), a cellular telephone or similar electronic computing device that manipulates and transforms data represented as physical (electronic) quantities within the computer system's registers and memories into other data similarly represented as physical quantities within the computer system memories or registers or other such information storage, transmission or display devices.

The present invention also relates to an apparatus for performing the operations herein. This apparatus may be specifically constructed for the required purposes, or it may comprise a general-purpose computer selectively activated or reconfigured by a computer program stored in the computer. Such a computer program may be stored in a computer readable storage medium, such as, but not limited to, any type of disk including floppy disks, optical discs, CD-ROMs, magnetic-optical disks, read only memories (ROMs), random access memories (RAMs), EPROMs, EEPROMs, magnetic or optical cards, flash memories or drives, or any type of media suitable for storing electronic instructions, each coupled to a computer system bus.

Finally, the methods, algorithms and displays presented herein are not inherently related to any particular computer or other apparatus. Various general-purpose systems may be used with programs in accordance with the teachings herein, or it may prove convenient to construct more specialized apparatus to perform the required method steps. The required structure for a variety of these systems will appear from the description below. In addition, the present invention is not described with reference to any particular programming language. It will be appreciated that a variety of programming languages may be used to implement the teachings of the invention as described herein.

In one embodiment of the present invention, the application described throughout is referred to as the Critical Path system or the EHSOLUTION System or some variant thereof. In one embodiment, the Critical Path is a subscription based system. A company will purchase a license for a subscription to the service. Their subscription then lives independently from the other subscriptions. The subscription's owners and/or administrators are capable of managing their own subscription, its users, locations and data. The number of users, locations, etc. in a subscription is solely dependent on the usage of the subscription but it is likely that some will have 500+ locations created each year with even more users.

Overview

The Critical Path system manages two types of customer needs: New Location Task Completion and Enterprise-Wide Project Initiative Tracking.

The Critical Path system solves the franchise community's challenge by providing an online web application. The application is capable of managing the thousands of tasks applicable to each location and provides the ability for Franchisors to communicate changes in a streamlined fashion. Relating to post-opening initiatives, Franchisors are also able to create a series of projects and initiatives that are the pushed down to applicable locations to implement.

Baselines are created by Franchisors to document the relevant tasks necessary for a successful opening. A subscription can include numerous baselines, each with a specific purpose. For example, a fast-food burger restaurant will have a baseline that is applicable to all restaurants. Additional baselines are created for specific location attributes: a baseline for locations that have a drive thru, a baseline for locations that have a playground, or a baseline for units located in a shopping mall food court. Baselines are organized not by specific date, but by the number of days and weeks prior to opening or prior to project completion.

When creating a location, one or multiple baselines can be used to ‘build’ a location in the application. This allows an administrator to build a location task list that is truly specific to the location's attributes. Selected baselines are joined together to create one task list for the location. By indicating the location's opening date or date the project should be implemented, each task is marked with a specific due date—subtracting the completion date by the number of days/weeks prior to completion that the task due.

After a location's task list is created, property level users can view, update and complete the tasks to update their overall progression. Each task contains restricted and unrestricted fields. Restricted fields cannot be changed by the location's users. Unrestricted fields can be altered. Restricted fields include the task name, additional information, contact name and details, hyperlinks, and task identifiers such as the department, discipline, project phase, community level, and an indicator noting if the task is considered a milestone.

Unrestricted fields include the tasks' due date, status and who is responsible for completing the task. Location level users may also add notes and upload files to the task or even request assistance, proving a one-stop approach for all communication related to the location's progression with the task.

By having restricted fields, administrators are able to update these fields across all locations at the same time. If the contact (person to contact for assistance) for a task is changed from John to Susan, this update can be quickly applied to all locations in the application at once. This is true for all restricted fields.

Administrators use a UI referred to herein as Baseline World to manage Baselines, Task Updates and New Task Pushdown.

Additional tasks based on new learning or initiative can be communicated to multiple locations at the same time using Task Pushdown. Administrators are able create the task, inputting Restricted fields, and then dictate the number of weeks/days prior to opening a task should be completed. The task is added to the task list for every location (based on a selection) with the correct due date (subtracting the number of weeks/days prior from the opening date).

Administrators also have the ability to create the task based on the project's due date versus the opening date.

Projects are groupings of tasks. An entire project can be pushed down to multiple locations at once. Based on location attributes, the administrator is able to pinpoint which locations should be included. In order to be included, locations are first added to a Project's Scope.

As restricted data on tasks change, administrators are able to update the information application-wide, at all locations with the task. For example, the task name needs to be further refined or the email address of a contact changes. This ‘restricted field’ data can be revised; once saved, new data will be updated on all locations with the task.

The Project Dashboard provides administrators with an overview of their project. Project Metrics detail the number of locations that are in scope, the number of locations that have received the tasks, locations that have started the project and number of locations that certify that the project has been completed. These metrics are displayed based on location identifiers/attributes. For example, regions or continents or management companies can be compared. All Project Management related items can be completed from this UI including creating the project's task list and monitoring any files that have been uploaded that are associated with the project. Submitted files may be reviewed and potentially approved by an administrator.

The Corporate Dashboard provides above location users with an overview of all locations in which the users has access. A graphical representation is provided for each location so the user can quickly assess the overall progression of the location's task list. Tasks included in the graphs include pre-opening tasks and/or tasks associated with a post-opening project that has been assigned to the location. Code exists to hide locations which are already open and that do not have any current tasks. The corporate dashboard also provides the user with the ability to view any tasks that the user is responsible for completing in the near future—this list is not location specific, but user specific and will display all tasks assigned to the user's name. Additional features include the ability to view missed milestones from any location and tasks that the location is requesting assistance in completing.

Location Dashboard provides graphical representation of how the location is progressing with their tasks. Similar to the corporate dashboard, but additional graphs are presented, dissecting the data in different ways. In one important aspect of one embodiment of the present invention, each master task list (each location list corresponding to each location) would be dated differently (based, for example, on franchise preparation timeline) and this would have a corresponding impact in creating the master task list. In one aspect of one embodiment, the baselines stack regardless of actual dates; and when baselines/tasks are pushed down to multiple locations each task associates with a date based on the franchise's unique timeline.

Detailed Discussion

In one embodiment, the Critical Path system has completely dependent modules for subscriptions, locations, location-based tasks, users and their profiles, etc. The system will enable each module to essentially communicate with other modules through well-defined interfaces. This will facilitate the acquisition of data required to complete each module's specific operation as well as make changes to the shared data utilized by the other modules within the same database. These are not distributed-database operations.

In one embodiment, the concept of a database web service is central to Service-Oriented Database Architecture (SODA) and its scalability model. From a logical perspective, a database web service exposes a well-documented application-level interface to data. This is not a general database interface for reading and writing data, rather it provides very specific application functionality. For example, a subscription web service might expose methods for retrieving subscription users, manage identifiers, manage subscription users, etc.

In one embodiment, the first difference between database web services and traditional models is that access to data under the control of a single module service is completely isolated from access to other module database services (i.e., a Location Module database service never directly manipulates the tables associated with Tasks. It always manipulates Tasks by calling the Task database web service). This makes scaling out the system's functionality very easy. The second difference is that requests to database services are not made over a database connection but rather are exposed as Web Services. SQL Azure (MICROSOFT WINDOWS AZURE SQL Database is a cloud-based relational database platform built on SQL Server technologies) may be used to meet the purpose of multiple servers. SQL AZURE provides elasticity in the scale out offering as an application can increase the number of databases when needed and decrease when the requirements change.

In one embodiment, the Critical Path system is compatible with existing internet browsers and also has backwards compatibility with outdated internet browsers such as INTERNET EXPLORER 6, FIREFOX 3, and SAFARI 4. There is flexibility in how graphs are displayed as well as how the general UI is able to be. The flexibility is exploited to provide the Critical Path system with not only enterprise level capability, but also a public-facing level of design which users will enjoy seeing and working with on a day-to-day basis.

In one embodiment, live database content migration to new applications is part of the Critical Path system. The system takes into consideration the existing live site's data migration via import/export XLS file functionality.

In one embodiment, the EHSOLUTION System has certain system security and access requirements. At login, the application system must validate the user identifier and user authenticator as a pair and reject the logon attempt if it is invalid. The system must not inform the user which of the two is wrong. Any blank spaces at the end of the username should be removed prior to submitting for authentication. In one embodiment, the system will: 1) Assign all users, including programmers and system administrators, a unique ID before allowing them to access system components, properly restrict backdoor access to system to authorized individuals. 2) Encryption: At a minimum least SSLv3, TLS, or equivalent encryption on the user's initial logon to the Web Server to validate the authenticity of the server and protect the logon authentication process. 3) Browser tracking: Only digitally signed JAVA Applets ACTIVEX Control Files should be downloaded to the client's web browser. 4) Password Masking: Passwords must not appear, or must be masked, on the screen when entered. 5) Password Traits: Passwords must be a minimum length of seven random, alphanumeric characters which are unrelated to User Id, random characters in the password must contain at least one number (or special character) and one alpha character, entire password may not be all numbers nor may they be all alpha characters, users must be prevented from using the previous 4 passwords during a password change, render all passwords unreadable during transmission and storage on all system components using strong cryptography, successful logons must display the date and time of the last logon and logoff. 6) Inactivity Log-off: the system must disconnect the session after 15-minutes of inactivity, must recognize pages using AJAX as activity, needs to go back to the same page when login is required (pages should redirect back to where the user was prior to time-out), alternatively, if the native technology or infrastructure provides the capability, a screen saver, or some other locking mechanism, that required user re-authentication, must be employed to prevent unauthorized access to the session, user re-authentication must be employed to prevent unauthorized access to the session post log-off, after reactivation, the user should be redirected to the previously used page. 7) Credential Deactivation: After 6 consecutive failed logon attempts, user accounts must be deactivated for a minimum duration of 30 minutes, Subscription Administrators and those user roles above the Subscription Administrator are able to re-enable access to the user's account. 8) Failed Attempt Log: All erroneous password entries must be recorded in an audit log for later inspection by Subscription Owners and EHSOLUTION Admin only. 9) Password Database Entry Traits: password entries must be encrypted. 10) Auto Login: Single Sign on. 11) Forgot Password Feature: this feature is only available if EID integration is disabled, three security questions must be answered correctly for verification, any blank spaces at the end of the email address should be removed prior to submitting. 12) If answers are not correct, answers to the users secret questions may be sent via email, and only after a manual (through conversation over the telephone) confirmation will admin command the system to send the email with a temporary one-time password. The user is permitted entry and is required to change their password. Users that attempt to skip this process by going to a specific URL will be reverted back to change password. Upon the input of successful answers, the user is permitted entry and is required to change their password. Users that attempt to skip this process by going to a specific URL will be reverted back to change password. Forgot Password Feature is not available to inactive users. User should be notified that their account is not active when attempting to reset their password. 13) Change Password: This feature is only available if EID integration is disabled. The user will be able to update their password. User will need to re-input their current password to change their password. User will be able to change password through user's profile page. A link for changing password will be available in User's profile page. 14) Password Change-Security Question: This feature is only available if EID integration is disabled. The user will be able to update forgot password question. The user will need to re-input their current password to access their questions/answers. A link will be available below change password to change forgot password question. Subscription Administrator will be able to look up security questions or email out a temporary password. 15) Password Expiration: Users will be required via an automatic system expiration to change their passwords every 90 days. After completing the password change, the user will be directed to their normal and landing page. If EID integration is disabled, then User account must be deactivated after 90 days if there has been no account activity. 16) Multiple Subscription Routing: After successful login, users with active accounts in more than one subscription should be prompted with which subscription they would like to access/open. If EID integration is enabled for the selected subscription, then the user will be redirected to their profile screen. The user will have to specify their email address within their profile screen. An email verification link will need to be selected by the user which will send a verification link to the entered email account. Login page—cursor will be default in the username field. Pressing the Enter key in the Password field will activate the Login button. 17) Request Subscription Access: Login page will provide a link to Request Access similar to existing feature. Access Code will be needed for requesting access. Access Code will identify the subscription to which the user is requesting access, User will be prompted after successful submittal of Access Code with user profile registration page. Existing “Note” box will be relabeled with “Which locations would you like to access?” This registration will remain temporary until Administrator approves request. User will be informed like “Requests are reviewed by an Administrator and Approved/Denied within one business day”. 18) Landing Page: After successful login, if user has access to more than one subscription, user is provided with a choice on which subscription to access. Upon subscription selection, user will be navigated to their landed page based on their user group.

In one embodiment, the system contains user roles such as super administrator and system administrator with varying levels of access rights.

In one embodiment, the system contains a location management section with: 1) Subscription Moderator will Create/Edit/Inactivate/Activate Location. When a location is created, the user will be provided a list of baseline locations to use/import in order to populate the list of tasks for the new location. The user will choose one or more baselines to import. The list of baselines will be sorted alphabetically and display the baseline location name. Selected baselines will need to populate a “selected” list. List will show at least 10 baselines without the user having to scroll up/down. 2) Baseline tasks along with associated baseline users will be automatically assigned to new location. Associated baseline users will have access to the new location upon creation. 3) Subscription Owner/Administrator/Moderator will assign access to a user of a Location. A simple UI will be available to indicate who will have access to the location and to provide additional users access to the location. UI will also allow selecting project manager from assigned users of a Location. Any list of user names will be alphabetical by first name and will only include users that are active in the subscription. A search feature will be available to find users in the list faster. 4) Each subscription will have access to create multiple Baselines. Baselines have the same attributes of a standard location. The tasks in a Baseline will be joined with another Baseline to create a new location's task list. Management of Baseline locations and tasks is done the Baseline World UI. 5) List of locations will be alphabetical by location name and be paginated with 100 locations displayed per page on default. The list of locations will be searchable by location name. Filterable by location attributes Opening Manager, Abbreviation, Opening Date, and Date Created, Brand, Country, Region, management company, Market, Continent, Location Type and Active. Location ID will also be shown in the list. Search results will be retained if/when an action will be done on the list. For example, if location is selected and edit attributes, save and close. Then will be navigated back to the same results as before user clicked on the location's name. Default filters will be enabled when user opens UI—Active Locations only. Initial listing of locations should filter and display only locations that have an opening date after the current date. Locations noted as Baseline will not appear (as they will be listed in the Baseline World UI). 6) Subscription Moderator or higher will be able to change a location to Inactive. Once Inactive, it can be made Active again. Dashboards will not display graph of Inactivate Locations. Inactive location will not be available under Location filter of Tasks list page. Subscription Owner will be able to purge a location from the subscription. This action will physically remove location from database. All tasks that were assigned to that location will be permanently removed.

In one embodiment, there is key task management where Subscription Owner/Administrator/Moderator will be able to edit existing tasks via Key Task. Editing the task or its attributes, will update all tasks with the same name throughout the application. A task could have the same name, but created from a different baseline. Only tasks that are created from the same baseline should be updated. If user changes due date in key task then all tasks (Not Completed) will update with new due date.

In one embodiment, there is project dashboard. Project Baseline will be the same functionality as a Baseline Location—group of tasks that are either used to create a new location or be pushed down to existing locations. If Project Baseline feature will be inactive then Project Name and label will be hidden. Each task on a baseline project will be associated with a Project Name, which will likely be the same name as the Baseline name. The project name will carry across to the task list of the location, the same as to other Restricted Task values. Project Dashboard displays pertinent information regarding a specific project in an easy to process and utilize format. Project Dashboard displays project metrics and gives the user an overall idea about locations that are included in a project. Project dashboard will have certain project metrics: This page will have selected subscription associated logo and tool bar color theme. By default no project in the list will be selected; it will start with Select Project: User will have to select the project which is to be reviewed. Ability to filter totals by metrics—Management Company, Brand, Region, Market, Continent, Property Type, Country. Select two (2) metrics whose task comparison is to be done. Ability to filter totals by additional Optional Sub-Metric-Completion date, region, management company, market, brand etc. Metric will be displayed based on filtration of active locations. User will be able to hide/show metric filter criteria section. Each number in the metric grid result will be hyperlink to a list of locations in which makes up the number. This link will navigate to list of tasks along with selected filter.

In one embodiment, there are general user rights and a community role where the tasks which are displayed will be associated with a community that is equal to or lower than the user's community. When a user creates a new task, the user can either assign the task to the user's community or a lower level community. The tasks visible in the list are based on the user's community. A user may view tasks at a community equal or lower than their community, but may not view tasks in a higher community. Each uses may be assigned to a community.

In one embodiment, there is a corporate dashboard focused on monitoring multiple Location's opening progression. Corporate dashboard provides a stacked bar graph for each unit. Each piece of the stacked-bar graph represents the number of tasks in each status. The locations displayed are based on the user's rights to view a location. There may often be times when hundreds of locations are displayed on the Corporate Dashboard. The Corporate Dashboard combines information that illustrates the obstacles and overall progression of active locations the user has been provided access to and active locations have at least one task. Locations can be filtered by Project, Management Company, Brand, Opening Manager, Continent, Country and opening date range.

In one embodiment, there is a location dashboard that displays pertinent information regarding a specific Location in an easy to process and utilize format. The location dashboard provides an overview of all tasks assigned and each core area is also displayed with a graph. A user may drilldown to view a task list for a specific core area and/or status. User will have the ability to attach files to the Location Dashboard. User will be able to upload all files except .dll and .exe. File size maximum may be 4 MB. When uploading a file, user will need to create attribute of the file: Name, Description, Location, Approved By, Department (sorted alphabetically), and Associated Project (sort alphabetically if the Project feature is active) or Task (sort alphabetically). Name, Description, Location, Project (if project feature enabled) will be required fields. File uploading process will be reviewed by simple progress bar FLASH control.

In one embodiment, there is a SHAREPOINT Dashboard for clients that have active SHAREPOINT sites. This allows the client to include location dashboard in a Web Part.

In one embodiment, there is a task list wherein the tasks visible in the list will be based on the user's community. A user will view tasks at a community at the same or lower than their community, but will not view tasks in a higher community. The talk list may contain detailed abilities for the following: Listing Traits, Add Task, Quick Update, Task list formatting, Listing Attributes, Filter Traits, My To Do Filter, Location Filter, Status Filter, Task Assigned To Filter, Department Filter, Due Date Filter, Milestone Filter, Discipline Filter, Search, Clear Search, Clear All Filters, Show All Tasks, Select All/Clear All, Delete, Print Report, Project filter, Restricted Attributes, Our Notes, and Files.

In one embodiment, there are miscellaneous functions with alerts and updates, and detailed abilities for the following: User Profile Preferences, Email Format Preference, New Support Case Alert (attributes), Missed Milestone Alert, Need Resources Alert, My Weekly Update, New Project Assigned, Request for New user, Creation of New Location, Request for New Support, Needs Resources, Section Labels, Support Escalation, Support Complete, and Administrative Alerts page order.

In one embodiment, there is Baseline World which will provide a new user interface to simplify the management of baseline templates, adding new tasks to existing locations and editing task details across all locations. Baseline World will centralize Templates, Key Tasks and Task Pushdown functionality that already exists. Baseline World will be available to Subscription Moderators and above. A Baseline has the same attributes as a Location. For simplicity, some attributes are hidden. Baseline templates are the set of tasks that will be used to create a location's task list. The template may also be pushed down to an existing location. Multiple baselines will be added together to create a new location.

In one embodiment, there are task profile attributes with restricted fields can be changed only by users with access to Baseline World (and with access to the baseline which houses the task). Updating a Restricted field, will update the field through the application for the specific task. This is a critical feature of the application. Key Tasks includes the functionality to update these restricted fields. Location specific fields may be populated from data in the Baseline location but ultimately are customizable for each location. A location level user may change these fields. By doing so, it has no impact on the baseline or other locations.

In one embodiment, the system contains Project Profile Attributes such as Name, Project Abbreviation, Implementation Manager, Communication Manager, Details, Highlights, Call To Action, Risks, QA, Box1, Box2, Welcome Subject line, Welcome email message, Certified Completion, Anticipated Completion Date, Actual Completion Date, Completed By, Created Date, and Created By. These attributes may have alphanumeric and special character, character types. They may be required or optional.

### DETAILED DESCRIPTION OF THE DRAWINGS

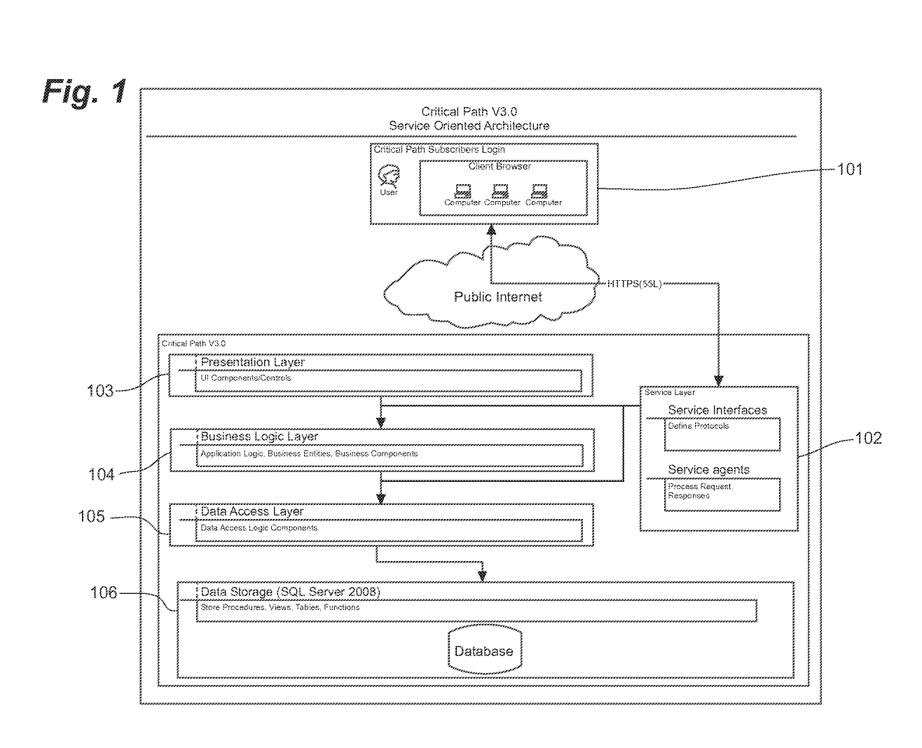

FIG. 1 is an overview diagram of an embodiment of the system architecture. One or more users 101 interface with the Critical Path system through one or more user terminals that connect to the system through an Internet connection. In order to expose business logic as a service, service interfaces must be created that support the communication contract (message-based communication, formats, protocols, security, exceptions, and so on) that are needed by its different consumers. Business components that require functionality provided in external services must communicate with those services. Service agents isolate the application from unconventional behavior of calling services and can re-map data as appropriate for the application. The access level determined by the service layer 102 pairs with an appropriate user interface 103. UI components allow users to interact with the application, and are implemented using smart clients or Web pages to acquire, validate, render and format user data. The Service Interfaces and Presentation layers then interact with the appropriate business logic 104 and data access 105 layers. The business layer 104 determines the user's access level prior to their interaction with server based data in data storage 106. Business components implement the business logic of the application. Abstracting the data access logic in a separate layer centralizes data access functionality and makes it easier to configure and maintain. Together these layers result in presenting the appropriate server-based data to users 101 for interaction.

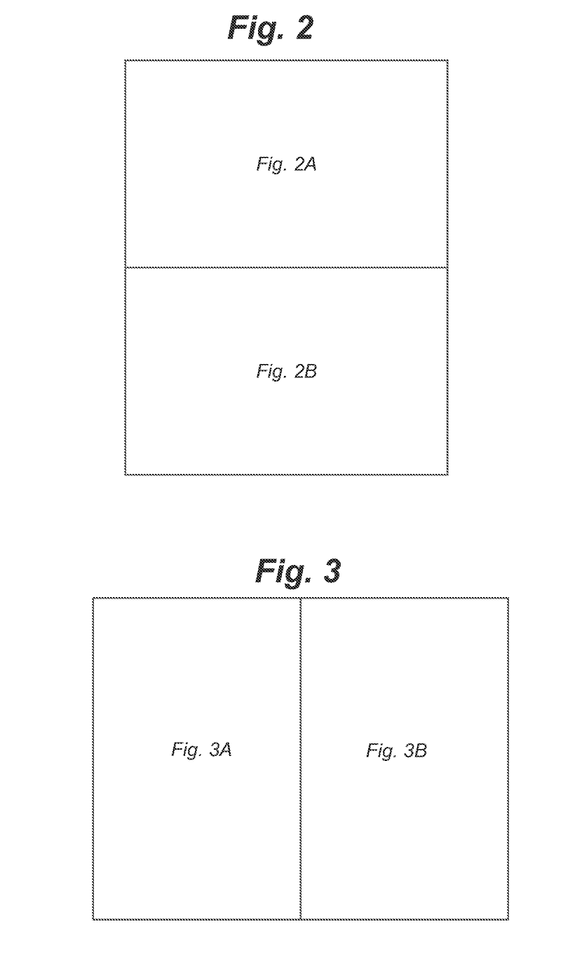

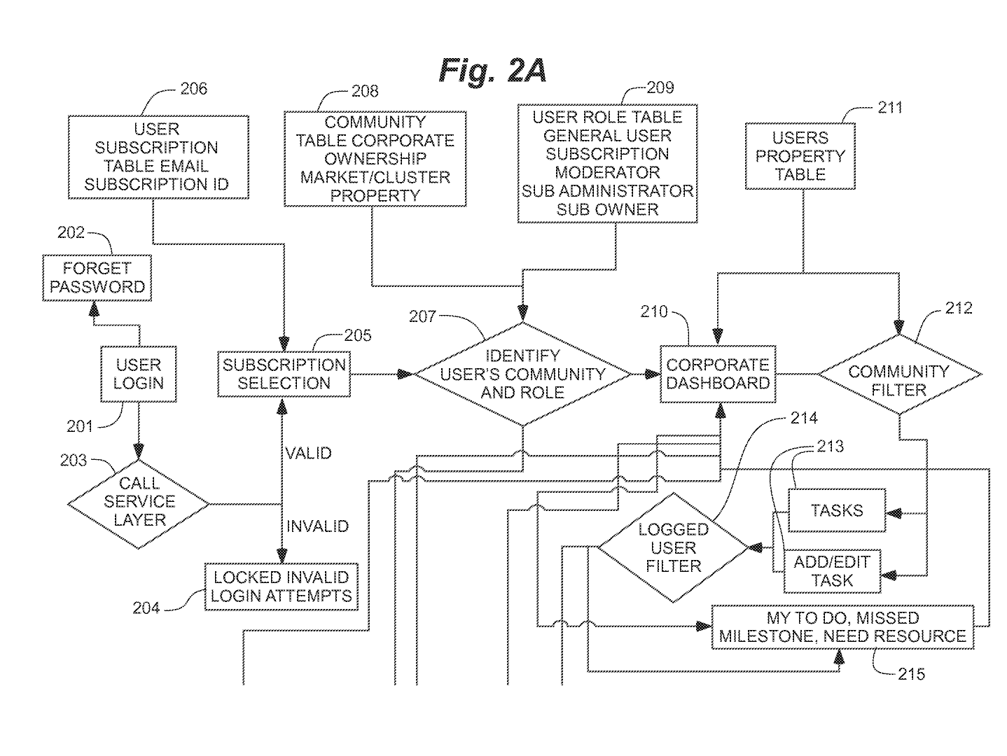

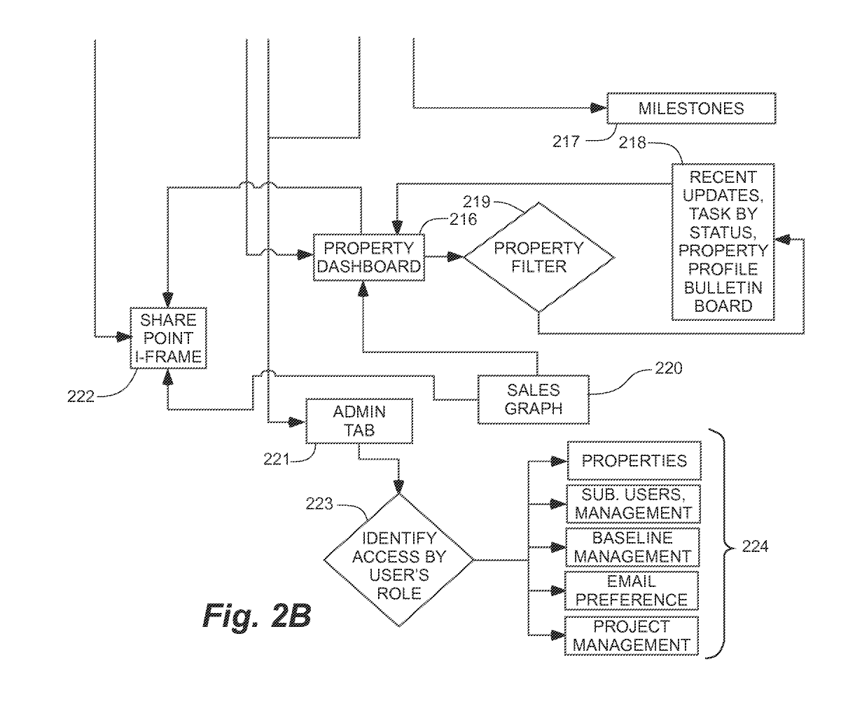

FIG. 2 (comprising FIGS. 2A and 2B) is an overview of an embodiment of the subscribers owner, administrator, moderator, and general user's system architecture. Users login 201 using their username and password. If they forget their password, they may be redirected to a password recovery option 202. The information they enter gets routed through a call service layer 203, which either blocks access 204 for an invalid login, or validates their information and sends them to subscription selection 205 where they can select which account they wish to access if they have multiple accounts. Account access is determined based on user subscription table 206, users are then routed after their selection to their user community and role/group 207 which is determined based on user community table 208 and user role table 209. After determining these credentials, users are sent to either corporate dashboard 210 or property dashboard 216 depending on their access levels. The corporate dashboard 210 is an overview of all the locations a user has access to. The user property table 211 is used to determine whether a user has access to a particular location, while the community filter 212 is used to identify hierarchy so that only tasks in a user's community or below are visible. This affects their interaction with tasks and their ability to view and edit tasks 213. The logged user filter 214 allows users to filter their task list, to toggle between all tasks and tasks specifically for an individual user. It allows “my to do,” milestones 215, and need resource lists to populate and/or be edited in the corporate dashboard 210. Milestones 217 and need resource are attributes that can be selected for a particular task in a binary manner. Users may either be directed at login to a property dashboard 216 or may drill-down from the corporate dashboard 210 to view a dashboard specific to one location. In property dashboard 216, the property filter 219 can be used to toggle between properties if the user has access, and to change the property being viewed and modified. It also displays recent updates, tasks by status, property profile, bulletin board, graphs, property status, and allows modification of files and projects 218. From the corporate or project dashboard, users may also interact with the share point I-frame 222, which functions like an export feature with additional characteristics. It pulls information from the property dashboard. Data such as a graph is provided a dynamic URL which can be put in a program such as MICROSOFT SHARE POINT so that it can be used in a presentation outside of the Critical Path System to show persons without user credentials. It may be an encrypted URL. This also dynamically updates, so that as the underlying server information changes the graph updates dynamically. Sales graph 220 can be turned on or off by subscription, and displays in the property dashboard or Share Point I-Frame. Users with appropriate access can also interface with the admin tab 221, which gives them the ability to identify user's access and edit that access by individual, community or role 223. Admins can edit a user's rights with regards to properties, managing sub-users, managing projects, managing baselines, managing projects, editing tasks, and user email preferences 224.

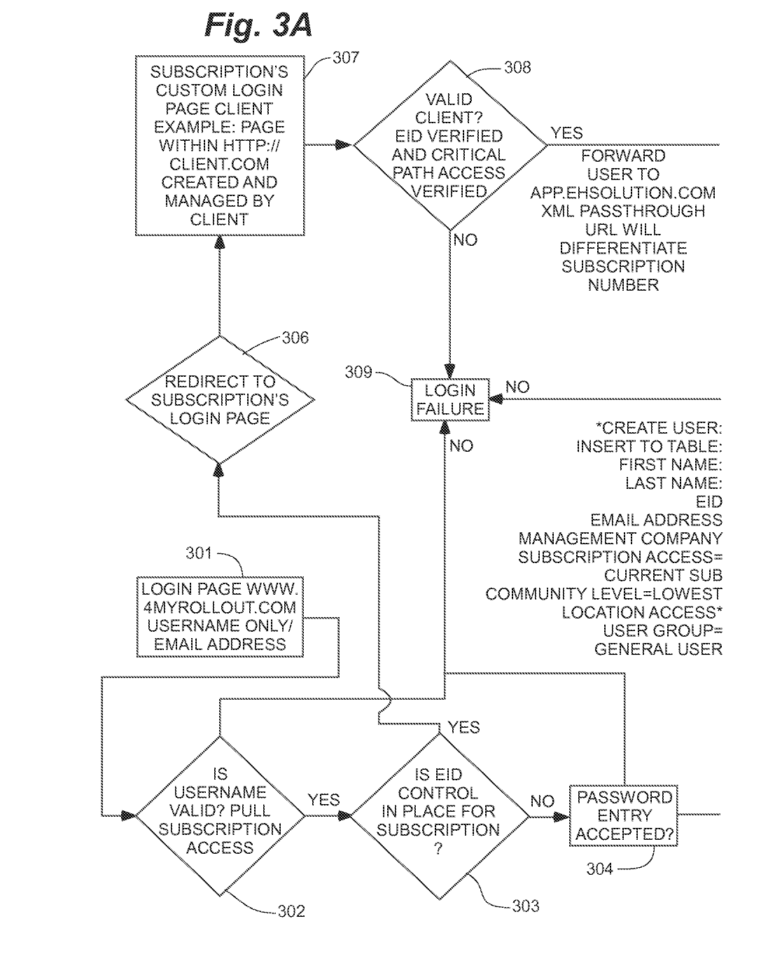

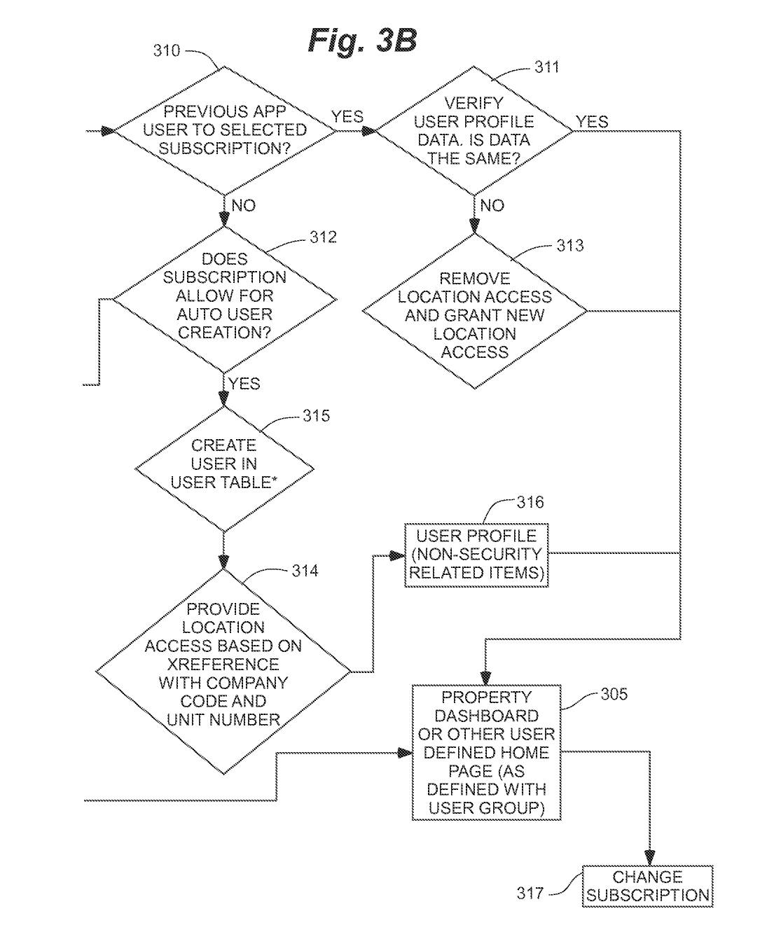

FIG. 3 (comprising FIGS. 3A and 3B) is an overview diagram of an embodiment of electronic identification and security system architecture. Clients may login directly at the Critical Path System website with their username only 301. The system will then determine whether they have a valid username 302. If not, their access will be rejected 309. If they do, the system will determine whether a subscriber account applies to the login 303. If it does, it will redirect the subscriber 306 to the client's login page 307. If there is not a subscriber account with a client login page, it will give them an option to input a password 304. If this is not a valid credential their login will be rejected 309, if it is a valid login they may proceed directly to the property dashboard or other defined home page 305. From there, they may also change their subscription to a different account if applicable 317 if the client was earlier redirected to the client login site, or if they went their initially, they may login through that portal 307. The Critical Path system can use the same username and password for this system that the client uses for their own employee electronic systems. This avoids the problems of having multiple users names and passwords for employees. If their credentials are rejected their access will be denied 309, if it is approved the system will determine whether they are an existing user 310. If yes, the system can verify whether their profile data is changed since their last login 311. If it is unchanged, they will be directed to the property dashboard 305. Their data might be different if they are now working at a new branch, or division, or company. If their data has changed, the system can remove their old location access and grant new location access 313 before directing them to the property dashboard 305. If, after logging in, they are a new user, the system can auto generate a user profile if permitted by the client 312. If the client does not permit, their login will fail 309. If the client does permit, the user table can be used to determine user profile and access 315. The new user can be assigned location access based on data supplied by the client 314 as well as other profile data 316.

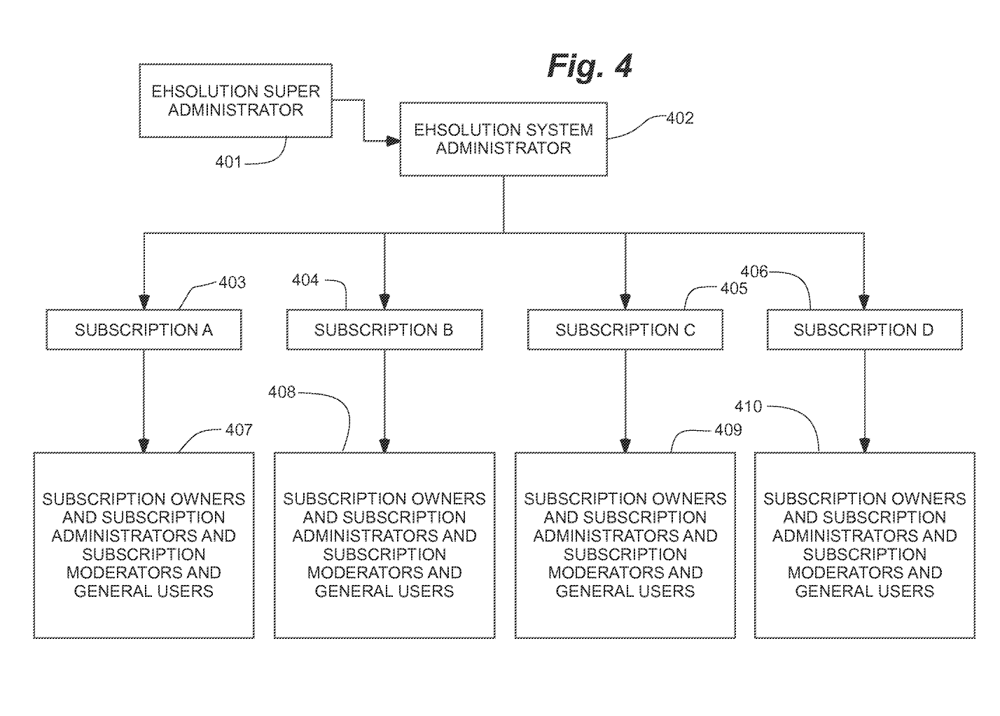

FIG. 4 illustrates an embodiment of hierarchical organization for subscription owners, administrators, moderators, and general users. An EHSOLUTION Super Administrator 401 has total access to every aspect of the system, A EHSOLUTION System Administrator 402 has administrative access only to specific customers or subscriptions. Each subscription account 403, 404, 405, 406 is independent of one another, and able to manage its own levels of users, tasks, etc., independently of other subscribers (subscription owners, subscription administrators, subscription moderators, and general users) 407, 408, 409, 410.

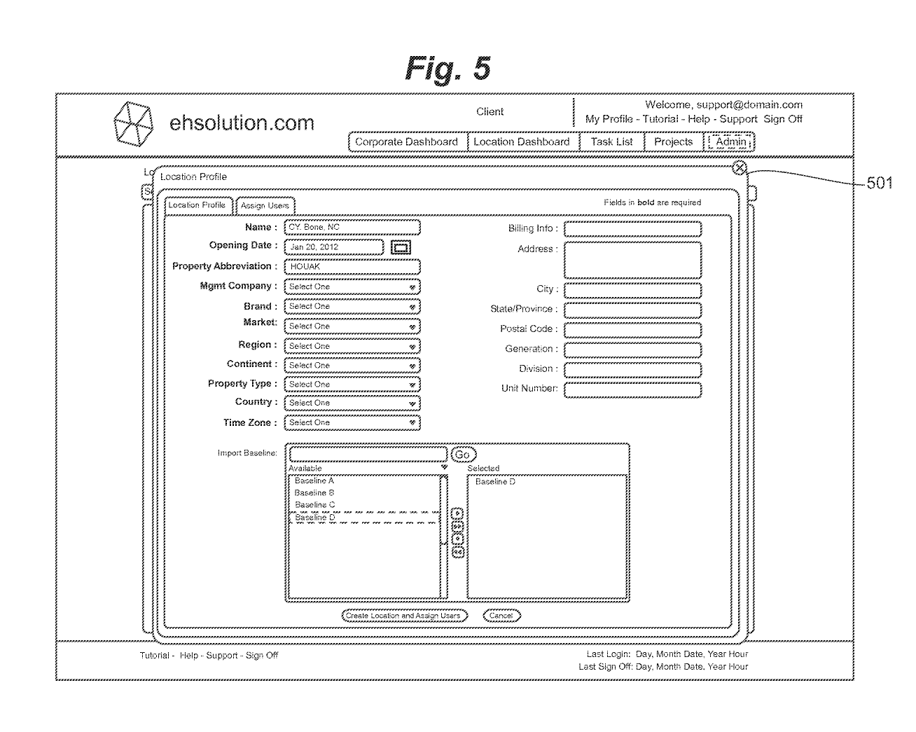

FIG. 5 illustrates an embodiment for location profile creation 501. The location profile creation allows a user with appropriate access permissions to create anew franchise location, and to associate certain information with that customer, such as name opening date, management company, property type, etc. It allows a user to select multiple baselines to associate with anew location. It further allows the display of various attributes regarding the property. This is an embodiment of how multiple baselines can be layered and used to create anew location.

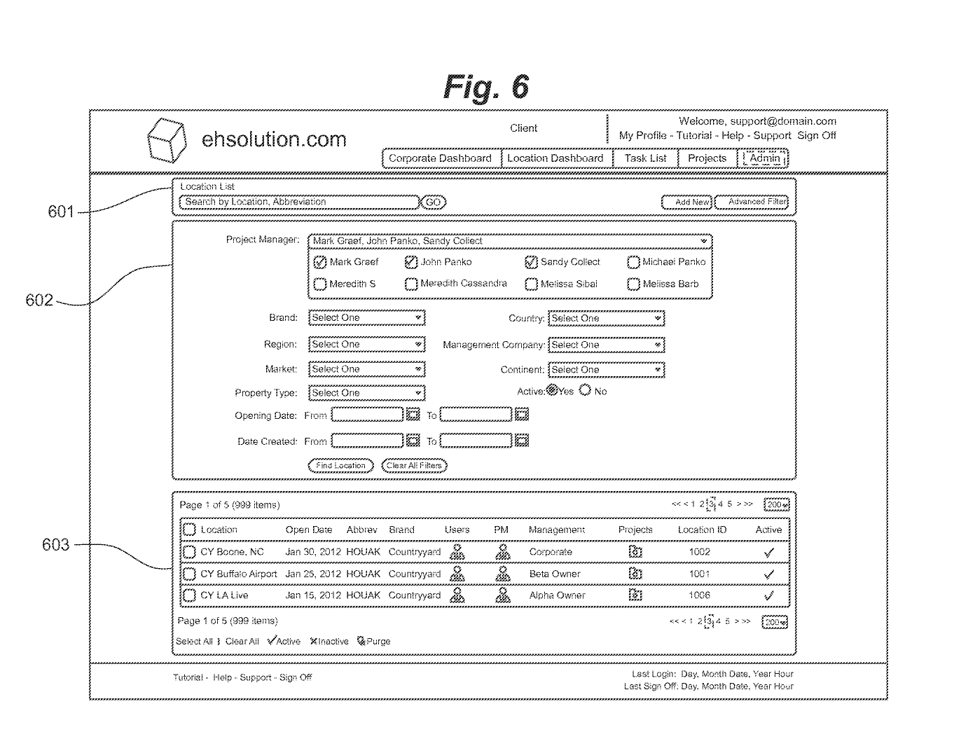

FIG. 6 illustrates an embodiment for users to search for a location. It contains a location list that allows users to search for a location 601, add a new location, or use advanced filters to search for a location. The system allows location search by a variety of filters 602, which populates a subset of locations 603. Through this interface, users can edit existing location profile information, for example to change a location's brand. Selecting a location will allow the user to edit that location profile. Users can also purge or inactivate locations. Changing the opening date will shift task due dates for the location by the same number of days.

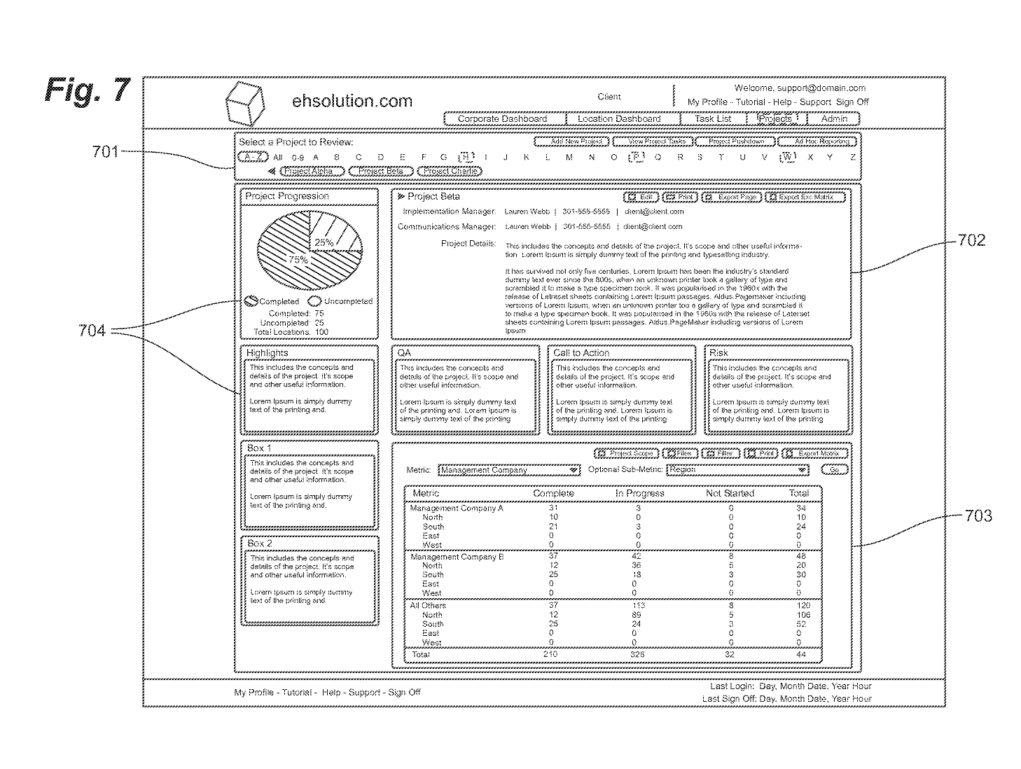

FIG. 7 illustrates an embodiment of the project dashboard. The Project Dashboard provides administrators with an overview of their project. Project Metrics 703 detail the number of locations that are in scope, the number of locations that have received the tasks, locations that have started the project and number of locations that certify that the project has been completed. These metrics are displayed based on location identifiers/attributes. For example, regions or continents or management companies can be compared. All Project Management related items can be completed from this UI including creating the project's task list and monitoring any files that have been uploaded that are associated with the project. Submitted files may be reviewed and potentially approved by an administrator. Users may select projects to review, add new projects or utilize project pushdown 701. Information on a project such as responsible person and contact information as well as details are displayed 702, and users can print or export information from the project dashboard. Export allows for ad-hoc reporting. Users are navigated to a user interface that allows for project reporting based on either location attributes or by project tasks. Boxes 704 display various information such as project highlights, project progression, risks, etc. Metrics, or location attributes, can be used like a filter to sort projects or subprojects. This may be used for example to compile a numerical data base on how many locations are working on a project, how many have not yet started, etc.

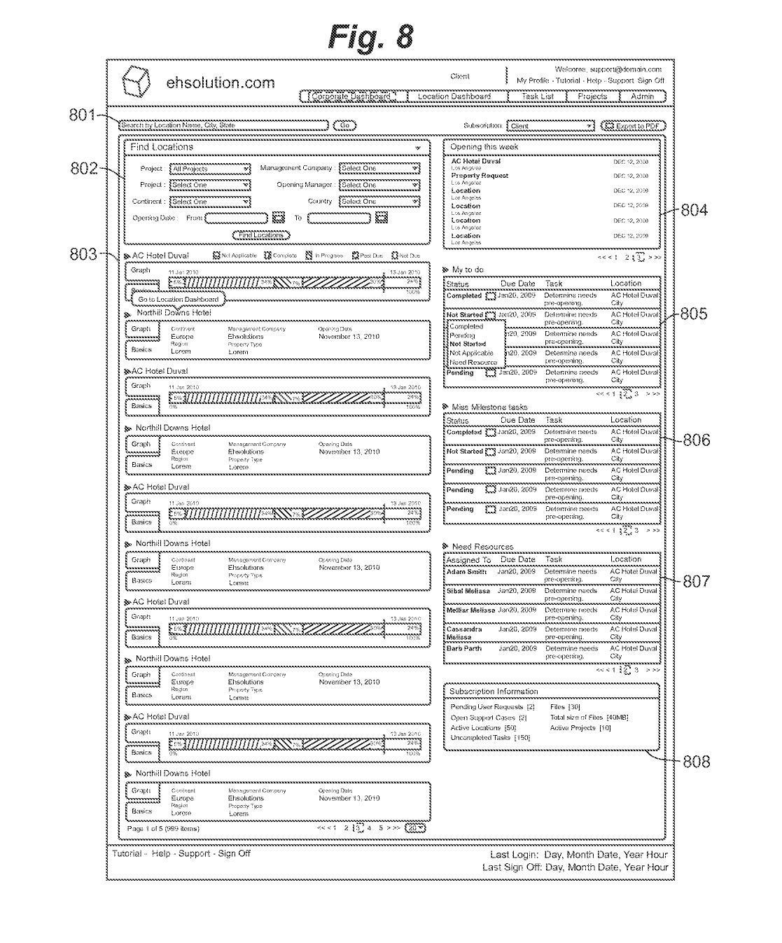

FIG. 8 illustrates an embodiment of the corporate dashboard. The Corporate Dashboard provides above location users with an overview of all locations in which the users has access. A graphical representation is provided for each location so the user can quickly assess the overall progression of the location's task list. Tasks included in the graphs include pre-opening tasks and/or tasks associated with a post-opening project that has been assigned to the location. Code exists to hide locations which are already open and that do not have any current tasks. The corporate dashboard also provides the user with the ability to view any tasks that the user is responsible for completing in the near future—this list is not location specific, but user specific and will display all tasks assigned to the user's name. Additional features include the ability to view missed milestones from any location and tasks that the location is requesting assistance in completing. Users can search by location directly 801 or by various filters 802. The corporate dashboard can then show the selection of locations searched for, or all locations. Each location an example of which is shown in 803 has a graph and basic tab. The Basic tab illustrates information about the location, the graph provides statistics related to task completion. For example, the pace at which tasks are being completed in relation to the pace at which corporate believes tasks should be completed. Hyperlinks allow users to navigate to the tasks list, a portion of the graph, or the relevant property dashboard. Users can also view locations by opening date 804, the user's individual to do list 805, missed milestone tasks 806, that is tasks identified as milestone tasks which are past due, tasks needing resources 807, and basic subscriber information 808.

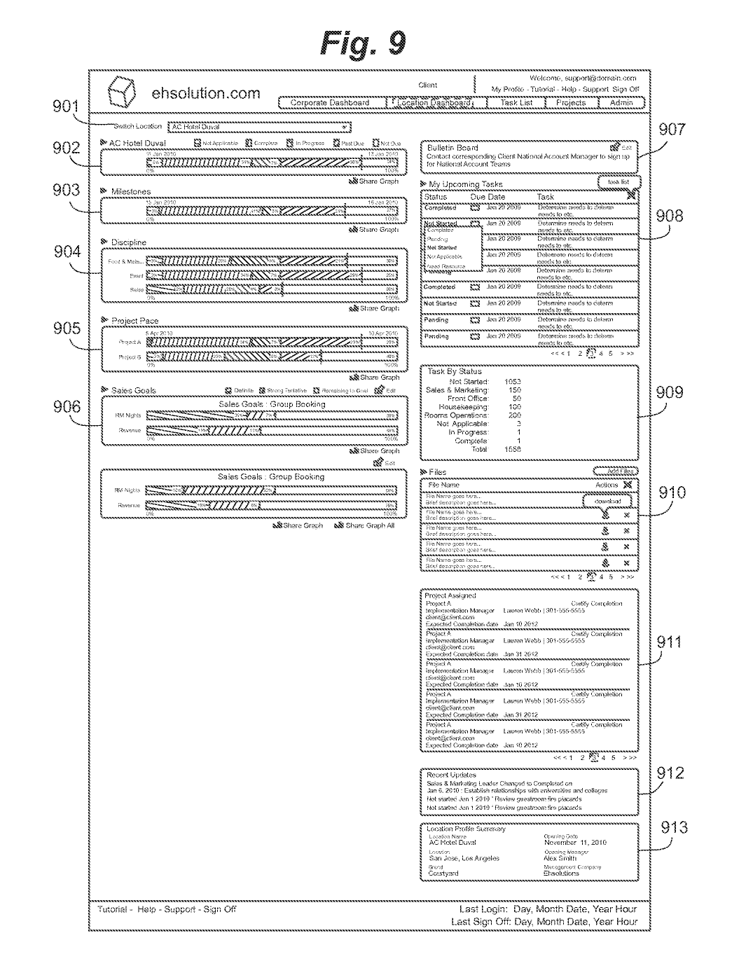

FIG. 9 illustrates an embodiment of the location dashboard, which provides graphical representation of how a location is progressing with its tasks. Users can select or switch locations being viewed 901. This dashboard breaks down properties with tasks along several dimensions, including overall 902, by milestone tasks 903, by tasks assigned to different disciplines 904, by the tasks assigned to different projects 905, or by sales goals 906. The graphs are subsets of overall project progression, and customers can define what types of goals they want to have and what goal representations they want. For example, a hotel might want to benchmark how many guestroom reservations they've made in advance of opening, or a gym how many memberships they've sold in advance of opening. Users can update progression to goal as applicable. Users can also leave notices on the Bulletin Board 907, as well as view tasks assigned to their user name 908. Tasks can also be viewed by status or sub-grouped by department such as front desk or housekeeping 909. Files can be uploaded or downloaded 910. A list of projects assigned to that location can be viewed 911, including by anticipated completion date, and completion of a project can be certified. Recent updates can be viewed 912, and information about the location is displayed 913.

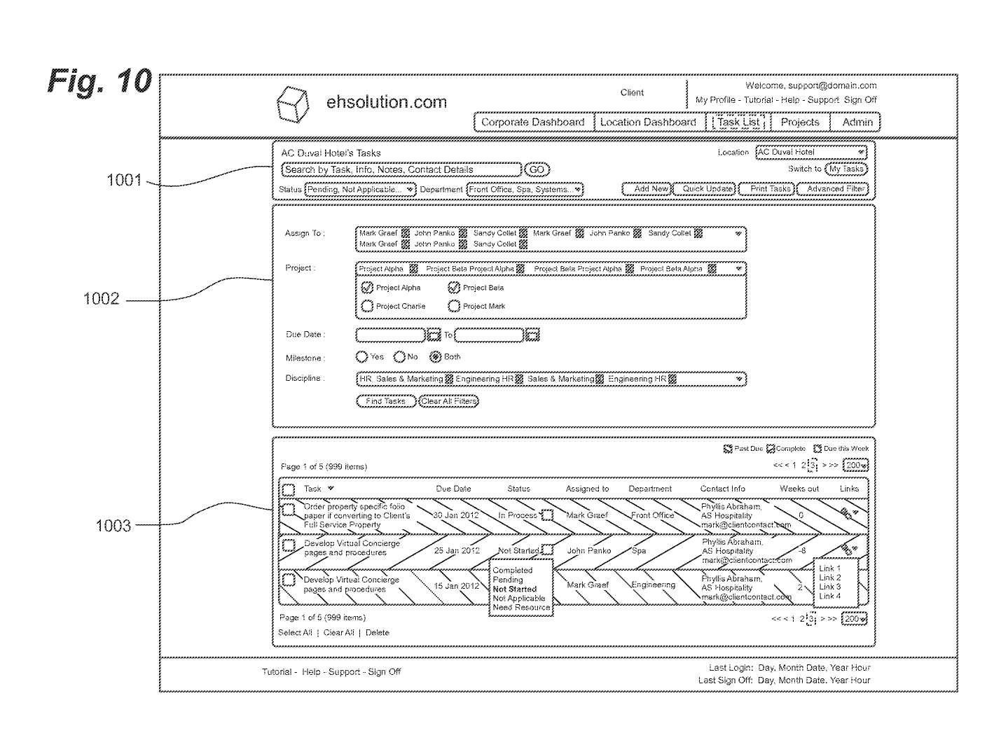

FIG. 10 illustrates an embodiment of a task list. A task is a single piece of work to be completed. Each task is associated with a timeline. Tasks may also contain additional identifiers for activities. By way of example, one task is to affix a welcome sign to the front of a building. The task further contains the contact information for a sign-maker and a corporate contact to report potential difficulties. The task list user interface contains all of the tasks assigned to a particular location which can be searched 1001 or filtered by additional attributes 1002, and new tasks can be added. Tasks can be edited 1002 for unrestricted fields including status, due date, and person assigned. Users can also toggle to see all the tasks for a location, or just the tasks associated with their name. Quick update 1003 allows selection of multiple tasks and changing multiple tasks at the same time. Selecting a task will redirect a user to the task profile.

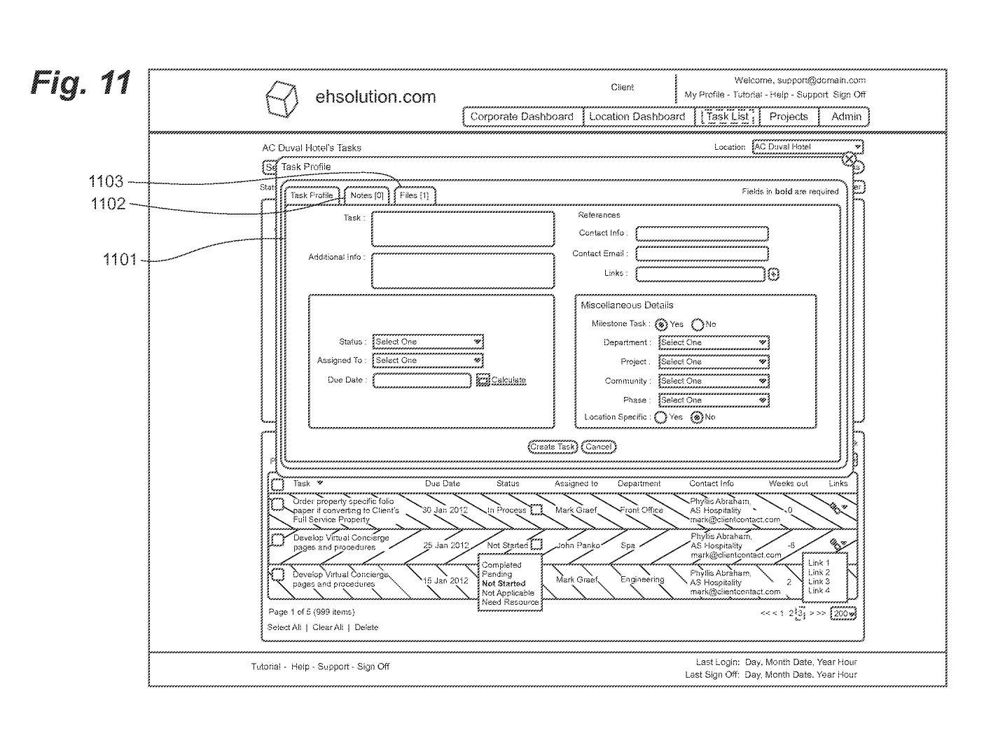

FIG. 11 illustrates an embodiment of task profile creation or edit, which includes all of the different attributes that make up a task, the task description, relevant reference material, and the person to contact for assistance if needed. Users may alter unrestricted fields in this interface 1101, but restricted fields must be changed in a different interface. Users may add notes 1102 which is additional commentary regarding a task, or add, delete, or download files 1103 that are relevant to the task.

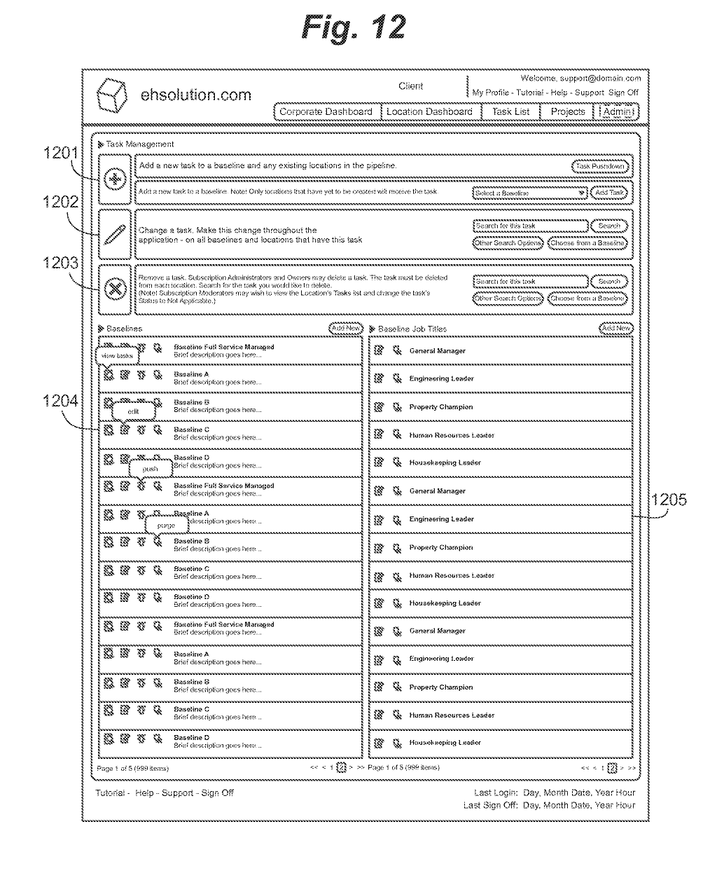

FIG. 12 illustrates an embodiment of Baseline World, a section from which a user with appropriate access will be able to perform entire Task Management. This allows tasks to be edited, added, or deleted from one or more baselines, including restricted fields 1201. Users may add tasks to multiple locations at the same time, which will be added relative to the number of weeks prior to project completion at a location. Alternatively, a task may also be added to a baseline, without impact to locations already using that baseline. A task may also be searched and changed across all locations 1202, or removed 1203. All client baselines are listed in the baseline depository 1204, where a baseline can also be edited or pushed down or purged. Baseline job titles are also listed 1205 and can be assigned to baseline tasks.

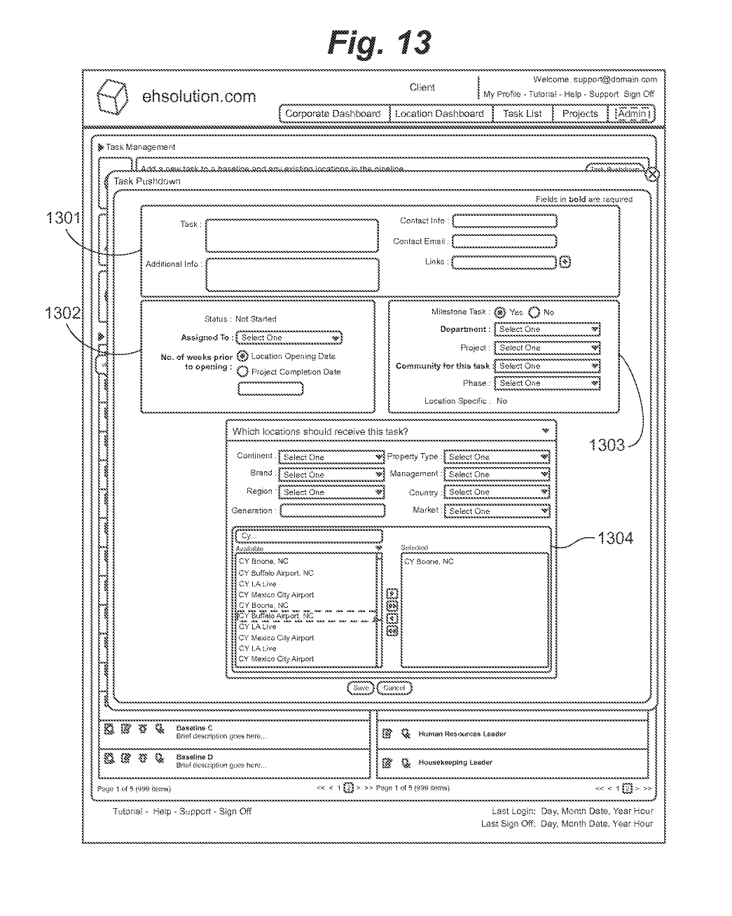

FIG. 13 illustrates an embodiment of task pushdown, which creates a new task 1301 with various attributes 1302 and creates it at multiple locations 1303. This interface can be accessed from Baseline World. Tasks enter location task lists based on weeks prior to completion, which is automatically calculated for each location. Locations may be selected in 1304.

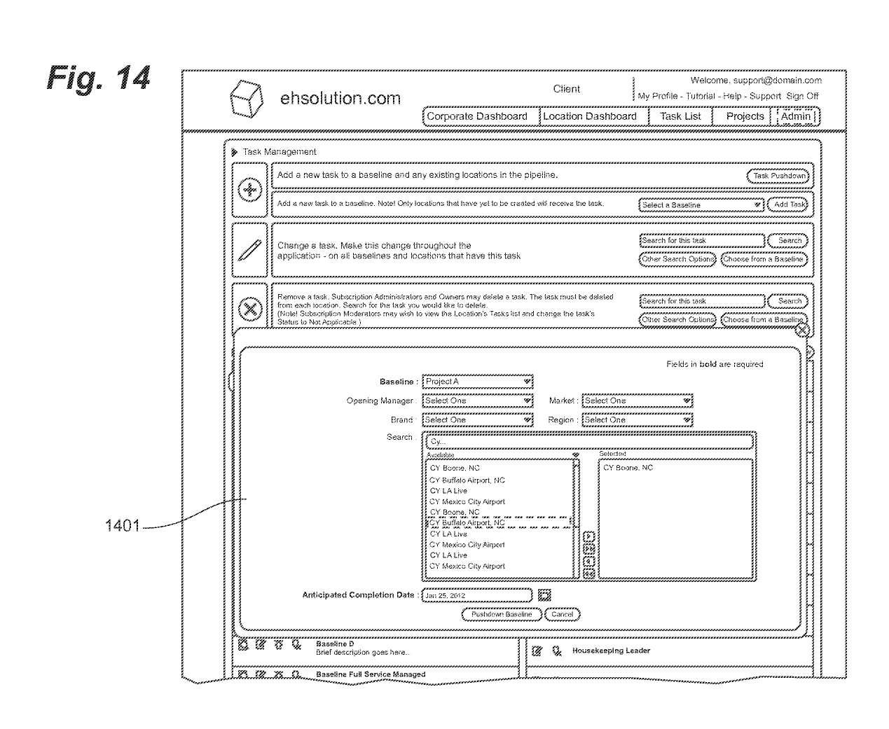

FIG. 14 illustrates an embodiment of project pushdown. From Baseline World, a baseline can be “pushed” to one or more particular locations 1401. This may be needed if a location was created without a needed baseline, and that mistake is being corrected. Or, if a location develops new needs, such as a restaurant that has decided it now wants an indoor play space. Baseline tasks are added with respect to a due date that the system calculates based on franchise preparation timeline.

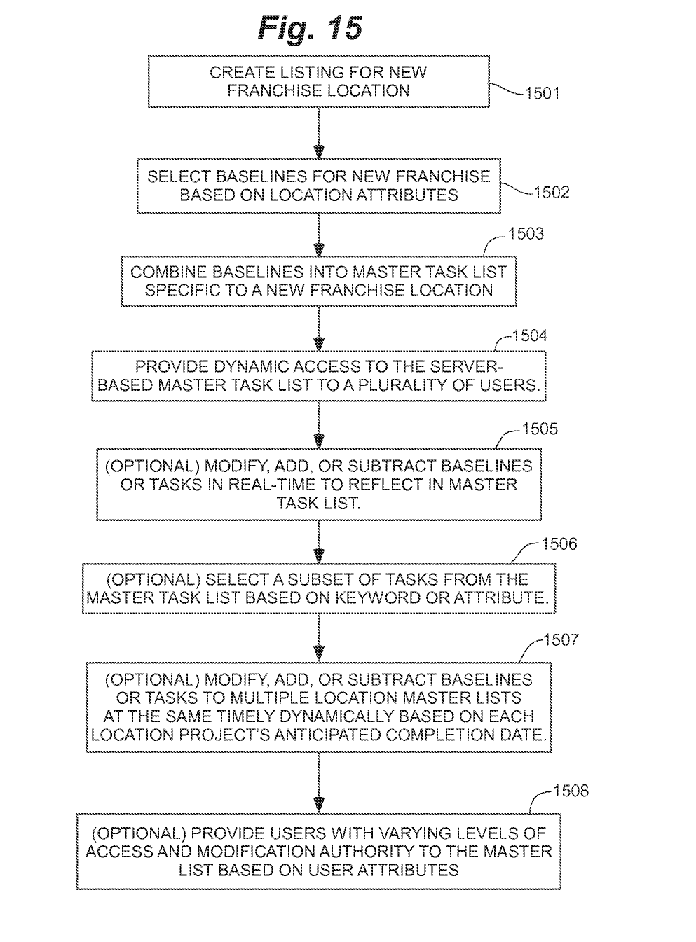

FIG. 15 illustrates a flowchart of an embodiment of a method according to the present invention. In step 1501, a user can create a listing for a new franchise location. In step 1502, a user can select baselines based on location attributes that the user can combine into a master task list specific to the new franchise location 1503. This master list can be stored on a centralized server and be shared dynamically with a plurality of users in real-time 1504. Users may add, subtract, or modify baselines or tasks in real time and these changes will be reflected in the master task list 1505. Users may select a subset of tasks from the mater task list based on keyword search or various attributes 1506. Users may add, subtract, or modify baselines or tasks to multiple location master lists at the same time dynamically based on each location project's anticipated completion date 1507. Tasks will appear at each location with a due date relative to the specific franchise location's preparation timeline. Users may have varying levels of access to view or modify baselines and tasks based on user assigned attributes 1508.

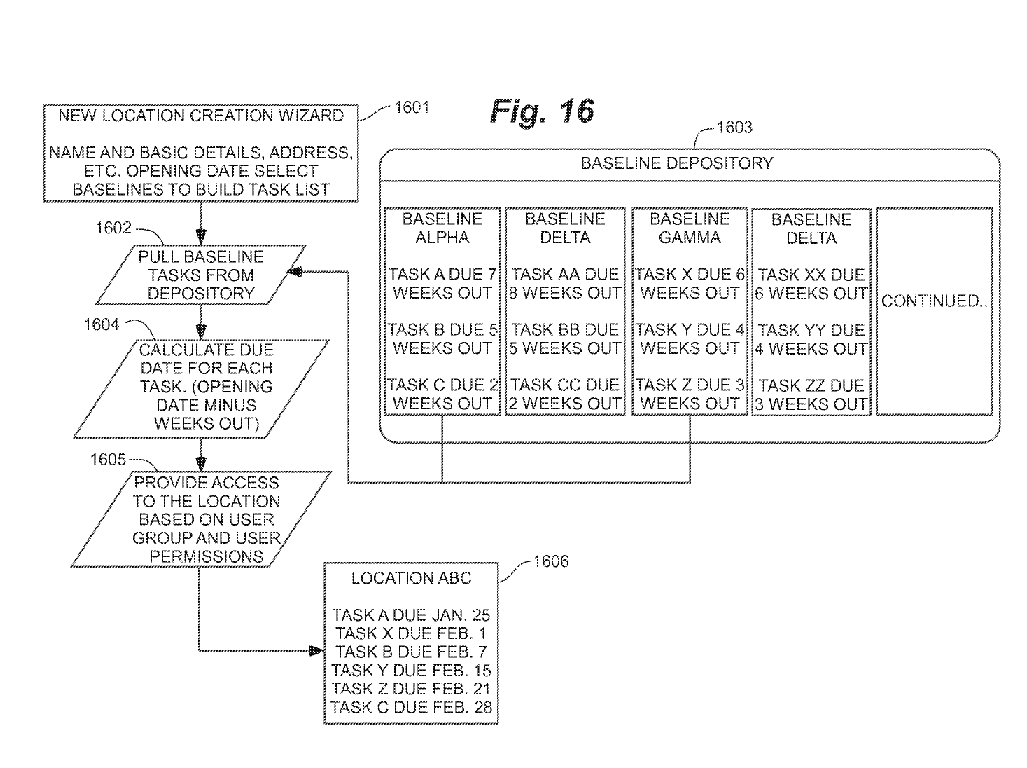

FIG. 16 illustrates a baseline depository according to one embodiment of the present invention wherein multiple baselines may be selected by a user to create a new location. A user may create one or more new locations 1601 then pull baseline tasks 1602 from a baseline depository 1603. These baseline tasks have a due date calculated for them based on location attributes 1604 and various levels of user access based on location and user permissions 1605. This information combines to produce a task list for one or more specific location 1606. In this figure, two of the baselines (Alpha and Gamma) have been selected from the entire depository.

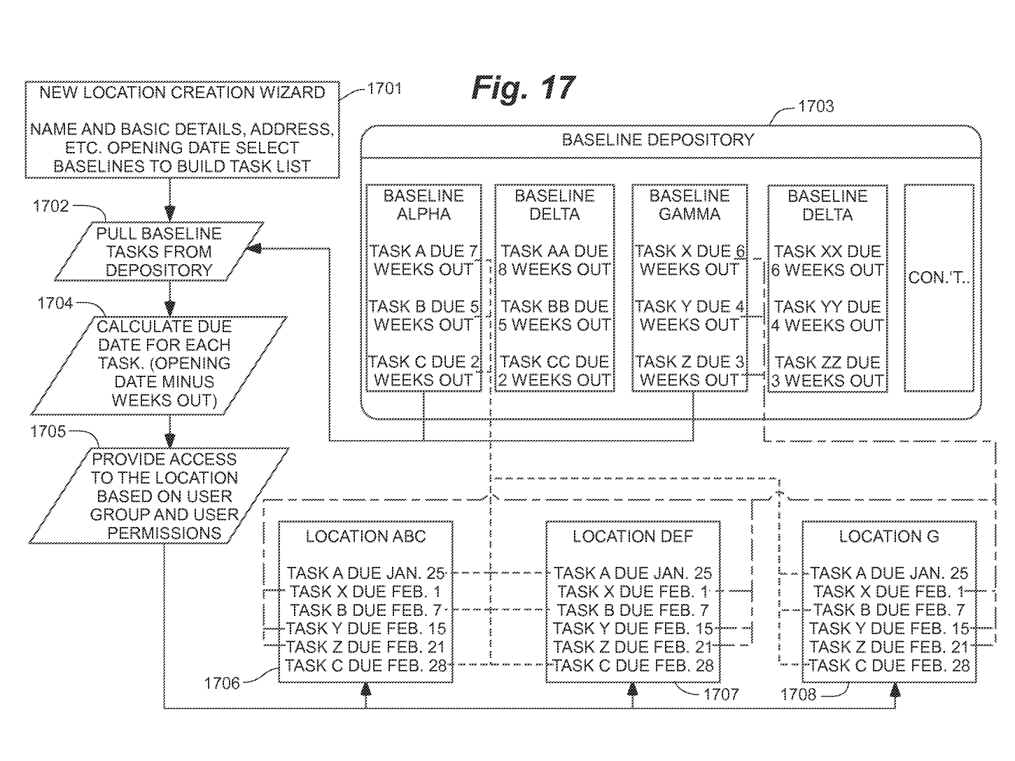

FIG. 17 illustrates a process in which once a location is created, restricted fields in each task remain linked to the baseline task, showing how if a restricted field is changed on the baseline task then the new data is immediately updated in the location's task. A user may create one or more new location 1701 then pull baseline tasks 1702 from a baseline depository 1703. These baseline tasks have a due date calculated for them based on location attributes 1704 and various levels of user access based on location and user permissions 1705. This information combines to produce a task list for one or more specific locations. In this figure, three locations were created 1706, 1707, and 1708. The tasks now exist independently for each location, except that as the underlying central baselines are edited that may continue to update in each location's task list based on the relevant baseline.

The foregoing description of the embodiments of the present invention has been presented for the purposes of illustration and description. It is not intended to be exhaustive or to limit the present invention to the precise form disclosed. Many modifications and variations are possible in light of the above teaching. As will be understood by those familiar with the art, the present invention may be embodied in other specific forms without departing from the spirit or essential characteristics thereof. Likewise, the particular naming and division of the modules, routines, features, attributes, methodologies and other aspects are not mandatory or significant, and the mechanisms that implement the present invention or its features may have different names, divisions or formats. Furthermore, as will be apparent to tone of ordinary skill in the relevant art, the modules, routines, features, attributes, methodologies and other aspects of the present invention can be implemented as software, hardware, firmware or any combination of the three. Also, wherever a component, an example of which is a module, of the present invention is implemented as software, the component can be implemented as a standalone program, as part of a larger program, as a plurality of separate programs, as a statically or dynamically linked library, as a kernel loadable module, as a device driver, or in every and any other way known now or in the future to those of ordinary skill in the art of computer programming. Additionally, the present invention is in no way limited to implementation in any specific programming language, or for any specific operating system or environment. Accordingly, the disclosure of the present invention is intended to be illustrative, but not limiting, of the scope of the present invention, which is set forth in the following claims.

What is claimed is:

1. A computer-implemented method for creating and managing a task list for one or more franchise locations in an online work management system accessible to one or more users by one or more user terminals, the method comprising the steps of:
creating one or more baselines, each baseline containing one or more tasks, each baseline corresponding to a particular attribute of a franchise location and containing a unique combination of tasks unique to said particular attribute of the franchise location, wherein the baselines may be modified in real-time based on changing tasks for a given baseline;
selecting one or more baselines from the created baselines based on attributes relevant to said franchise locations;
creating a master task list for the one or more franchise locations utilizing the one or more selected baselines based on the attributes relevant to said franchise locations;
combining said baselines to create said master task list, relevant to said franchise locations, said tasks each associated with a timeline of franchise preparation;
selecting a subset of the tasks from the master task list prepopulated by the selected baselines by filtering for an attribute selected from the set consisting of status, department, discipline, due date, personnel assigned to task, project name, and milestone;
adding one or more additional tasks to the master task list that are unique to each particular franchise location including information selected from the set consisting of task name, description, additional notes, due date, weeks out, personnel assigned to task, status, contact info, contact email, hyperlinks, milestone, department, community, phase, and project name;
adding one or more tasks to multiple locations at the same time dynamically based on each locations' project's anticipated completion date;
restricting access to viewing and modifying said tasks for the users based on the users' community and user group as determined by said baselines;
altering said community and said user group access dynamically based on changing baseline characteristics;
changing said tasks within said task list dynamically based on changes to corresponding baselines and the modification of baselines selected; and
providing said master task list on a user interface to the one or more users utilizing the one or more user terminals, wherein the master task list, an opening date, and associated timeline of franchise preparation are dynamically updated in real-time based on an intersection of the selected baselines, and the community and user group of the user whenever the baselines, community, and user group of the user is modified.

2. A computer-implemented method for creating and managing a task list for one or more franchise locations in an online work management system accessible to one or more users by one or more user terminals, the method comprising the steps of:
creating one or more baselines, each baseline containing one or more tasks, each baseline corresponding to a particular attribute of a franchise location and containing a unique combination of tasks unique to said particular attribute of the franchise location, wherein the baselines may be modified in real-time based on changing tasks for a given baseline; and
creating one or more task lists based on the baselines that are dynamically populated based on changes to the baselines.

3. The method of claim 2, further comprising:
selecting one or more baselines from the created baselines based on attributes relevant to said franchise locations.

4. The method of claim 3, further comprising:
creating a master task list for the one or more franchise locations utilizing the one or more selected baselines based on the attributes relevant to said franchise locations.

5. The method of claim 4, further comprising:
combining said baselines to create said master task list, relevant to said franchise locations, said tasks each associated with a timeline of franchise preparation.

6. The method of claim 5, further comprising:
selecting a subset of the tasks from the master task list prepopulated by the selected baselines by filtering for one or more attributes.

7. The method of claim 5, further comprising:
adding one or more additional tasks to the master task list that are unique to each particular franchise location.

8. The method of claim 5, further comprising:
adding one or more tasks to multiple locations at the same time dynamically based on each locations' project's anticipated completion date.

9. The method of claim 2, further comprising:
restricting access to viewing and modifying said tasks for the users based on the users' community and user group as determined by said baselines.

10. The method of claim 9, further comprising:
altering said community and said user group access dynamically based on changing baseline characteristics.

11. The method of claim 2, further comprising:
changing said tasks within said task list dynamically based on changes to corresponding baselines and modification of baselines.

12. The method of claim 4, further comprising:
providing said master task list on a user interface to the one or more users utilizing the one or more user terminals, wherein the master task list, an opening date, and associated timeline of franchise preparation are dynamically updated in real-time.

13. A system for creating and managing a task list for one or more franchise locations in an online work management system accessible to one or more users by one or more user terminals, comprising:
a processor for processing program code; and
one or more memories for storing program code, coupled to the processor, which when executed by the processor execute a process comprising the steps of:
creating one or more baselines, each baseline containing one or more tasks, each baseline corresponding to a particular attribute of a franchise location and containing a unique combination of tasks unique to said particular attribute of the franchise location, wherein the baselines may be modified in real-time based on changing tasks for a given baseline;
selecting one or more baselines from the created baselines based on attributes relevant to said franchise locations;
creating a master task list for the one or more franchise locations utilizing the one or more selected baselines based on the attributes relevant to said franchise locations;
combining said baselines to create said master task list, relevant to said franchise locations, said tasks each associated with a timeline of franchise preparation;
selecting a subset of the tasks from the master task list prepopulated by the selected baselines by filtering for an attribute selected from the set consisting of status, department, discipline, due date, personnel assigned to task, project name, and milestone;
adding one or more additional tasks to the master task list that are unique to each particular franchise location including information selected from the set consisting of task name, description, additional notes, due date, weeks out, personnel assigned to task, status, contact info, contact email, hyperlinks, milestone, department, community, phase, and project name;
adding one or more tasks to multiple locations at the same time dynamically based on each locations' project's anticipated completion date;
restricting access to viewing and modifying said tasks for the users based on the users' community and user group as determined by said baselines;
altering said community and said user group access dynamically based on changing baseline characteristics;
changing said tasks within said task list dynamically based on changes to corresponding baselines and the modification of baselines selected; and
providing said master task list on a user interface to the one or more users utilizing the one or more user terminals, wherein the master task list, an opening date, and associated timeline of franchise preparation are dynamically updated in real-time based on an intersection of the selected baselines, and the community and user group of the user whenever the baselines, community, and user group of the user is modified.

14. A system for creating and managing a task list for one or more franchise locations in an online work management system accessible to one or more users by one or more user terminals, comprising:
a processor for processing program code; and
one or more memories for storing program code, coupled to the processor, which when executed by the processor execute a process comprising the steps of:
creating one or more baselines, each baseline containing one or more tasks, each baseline corresponding to a particular attribute of a franchise location and containing a unique combination of tasks unique to said particular attribute of the franchise location, wherein the baselines may be modified in real-time based on changing tasks for a given baseline; and
creating one or more task lists based on the baselines that are dynamically populated based on changes to the baselines.

15. The system of claim 14, wherein the one or more memories store additional program code, which when executed causes the processor to execute the additional step of:
selecting one or more baselines from the created baselines based on attributes relevant to said franchise locations.

16. The system of claim 15, wherein the one or more memories store additional program code, which when executed causes the processor to execute the additional step of:
creating a master task list for the one or more franchise locations utilizing the one or more selected baselines based on the attributes relevant to said franchise locations.

17. The system of claim 16, wherein the one or more memories store additional program code, which when executed causes the processor to execute the additional step of:
combining one or more baselines to create said master task list, relevant to said franchise locations, said tasks each associated with a timeline of franchise preparation.

18. The system of claim 14, wherein the one or more memories store additional program code, which when executed causes the processor to execute the additional step of:
altering access to viewing and modifying tasks for users based on users' community and user group access dynamically based on changing baseline characteristics.

19. The system of claim 16, wherein the one or more memories store additional program code, which when executed causes the processor to execute the additional steps of:
adding one or more tasks to multiple locations at the same time dynamically based on each locations' project's anticipated completion date.

20. The system of claim 16, wherein the one or more memories store additional program code, which when executed causes the processor to execute the additional step of:
providing said master task list on a user interface to the one or more users utilizing the one or more user terminals, wherein the master task list, an opening date, and associated timeline of franchise preparation are dynamically updated in real-time.
